(19) United States
(12) Patent Application Publication
(10) Pub. No.: US 2026/0176734 A1
(43) Pub. Date: Jun. 25, 2026

(54) Optical Aluminum Alloy and a Preparation Method Thereof

(71) Applicant: Chinalco Materials Application Research Institution Co., Ltd., Beijing (CN)

(72) Inventors: Xiaodong MAO, Beijing (CN); Yingdong LI, Beijing (CN); Zhenning CHEN, Beijing (CN); Wei SONG, Beijing (CN); Huixue JIANG, Beijing (CN); Guoqiang HU, Beijing (CN); Guojun WANG, Beijing (CN); Mingdong HUANG, Beijing (CN)

(73) Assignee: Chinalco Materials Application Research Institution Co., Ltd., Beijing (CN)

(21) Appl. No.: 18/848,563

(22) PCT Filed: Feb. 27, 2024
(86) PCT No.: PCT/CN2024/078843

§ 371 Date: Sep. 19, 2024

(30) Foreign Application Priority Data
Jul. 12, 2023 (CN) 202310853828.0

(51) Int. Cl. C22F 1/047; B22D 11/00; C22C 1/02; C22C 21/08

(52) U.S. Cl. CPC C22F 1/047; B22D 11/003; C22C 1/026; C22C 21/08

(57) ABSTRACT

The present disclosure provides an optical aluminum alloy and a preparation method thereof. The preparation method includes the following steps: step S1, preparing an original aluminum alloy cast ingot from raw materials by adopting a semi-continuous casting process; step S2, subjecting the original aluminum alloy cast ingot to homogenization, head and tail cutting and skin turning, to obtain a surface treated alloy raw material; step S3, subjecting the surface treated alloy raw material to rapid solidification treatment through a melt spinning method to obtain a rapid solidification alloy strip; step S4: subjecting the rapid solidification alloy strip to crushing treatment and then to sheathing and cold pressing, to obtain a cold pressed blank; step S5, subjecting the cold pressed blank to 1-2 passes of hot extrusion procedures to prepare a bar; and step S6, subjecting the bar to solution treatment and aging treatment, to obtain the finished aluminum alloy material.

### TECHNICAL FIELD

The present disclosure relates to the technical field of aluminum alloy material preparation, in particular to an optical aluminum alloy and a preparation method thereof.

### BACKGROUND

Optical materials generally refer to metallic or non-metallic materials that show a mirror like effect due to high optical reflectivity. Ordinary optical materials with a surface reflectivity of ≥70% can meet application requirements, such as automotive interiors, decorative panels, and architectural ornaments, etc., however for optical device fields such as chips, radar, solar energy, light-emitting diodes (LEDs), and telescopes, etc., higher requirements are placed on the surface reflectivity of materials, which puts higher demands on optical materials. At present, the materials used in optical devices are mainly divided into two categories, i.e., metal materials and inorganic non-metallic materials such as glass ceramics, etc. Compared with non-metallic materials such as SiC ceramics, etc., metal materials have better processability and can fully utilize existing CNC milling processes to achieve the processing of complex structured optical devices.

Aluminum alloys have enormous potential in the aspect of manufacturing metal optical reflectors, etc., due to their lightweight, corrosion resistance, and specific mechanical/thermal properties. However, high-quality optical aluminum alloys used in high-end chips and high-end optical information fields mainly rely on imports, and the material supplies have long been monopolized by foreign manufacturers, greatly restricting the development of our country's semiconductor and high-end optical information industries. In recent years, a series of surface processing methods such as precision grinding, magnetic flow polishing, ion beam polishing, and plating (gold/silver), and the like has been adopted at home, to prepare mirror aluminum alloys with a optical surface reflectivity of ≥90% using 6061 aluminum alloy. However, it only meets the basic requirements for high-end semiconductor chips and high-end optical information applications.

The main factors affecting the surface smoothness of aluminum alloy materials include composition uniformity, microstructure uniformity, nano precipitation phase distribution uniformity, and residual stress control, etc. However, aluminum alloys prepared by traditional processes usually have strong chemical macrosegregation and uneven coarsening structure, and even ultra-high precision machining cannot achieve excellent surface smoothness. CN113234973B provides a high-quality mirror aluminum alloy material and preparation method thereof. By appropriately reducing the content of Si, Cu, and Mg in the aluminum alloy on the basis of the composition of traditional 6061 aluminum alloy material, while adding trace elements Ag and Pb, and introducing measures such as deep cold-deformation and vibration aging, etc., during the preparation process, the matrix structure morphology, and grain morphology and size of the alloy are effectively improved, and a mirror aluminum alloy with higher optical reflectivity is prepared. However, this technology only optimizes the original composition and preparation process to improve the composition uniformity and microstructure uniformity of the material, but still cannot meet the material requirements of high-precision optical aluminum alloys.

Therefore, how to further improve the optical surface reflectivity of aluminum alloy materials, break the monopoly of foreign countries on high-quality optical aluminum alloy materials for high-end chips and high-end optical information fields, and reduce the application cost of domestic optical materials has become an urgent technical problem that needs to be solved in this field.

### SUMMARY

The main object of the present disclosure is to provide an optical aluminum alloy and a preparation method thereof to solve the problem of low optical surface reflectivity of optical aluminum alloy materials in the prior art.

In order to achieve the above object, according to one aspect of the present disclosure, a preparation method of the optical aluminum alloy is provided, and the preparation method includes the following steps: step S1, preparing an original aluminum alloy cast ingot from raw materials by adopting a semi-continuous casting process, wherein the semi-continuous casting process includes subjecting the raw materials to heating melting, alloying, refining, slagging-off, standing, degassing, filtering and semi-continuous water-cooling casting; step S2, subjecting the original aluminum alloy cast ingot to homogenization, head and tail cutting and skin turning, to obtain a surface treated alloy raw material; step S3, subjecting the surface treated alloy raw material to rapid solidification treatment through a melt spinning method to obtain a rapid solidification alloy strip; step S4: subjecting the rapid solidification alloy strip to crushing treatment and then to sheathing and cold pressing, to obtain a cold pressed blank; step S5, subjecting the cold pressed blank to 1-2 passes of hot extrusion procedures to prepare a bar; and step S6, subjecting the bar to solution treatment and aging treatment, to obtain the finished aluminum alloy material.

Further, the original aluminum alloy cast ingot comprises the following components: a content of 0.40%-0.80% of Si, a content of ≤0.10% of Fe, a content of 0.15%-0.40% of Cu, a content of ≤0.10% of Mn, a content of 0.80%-1.20% of Mg, a content of 0.15%-0.30% of Cr, a content of ≤0.05% of Ni, a content of ≤0.25% of Zn, a content of 0.05%-0.15% of Ti, a content of 0.02%-0.04% of Zr, a content of ≤0.03% of V, a content of 0%-0.20% of Sc, with the balance being Al and impurities, the total amount of impurities being less than 0.15% and the content of each impurity element being less than 0.05%, all of which are in terms of mass percentage.

Further, the melt temperature of the alloy raw materials is 730-770° C.;
and/or, the filtration is carried out using a two-stage ceramic filter, with a first stage filter having a pore size of 35-45 mesh and a second stage filter having a pore size of 55-65 mesh;
and/or, the casting speed of the semi-continuous water-cooling casting is 20-50 mm/min, and the diameter of the original aluminum alloy cast ingot is 80-400 mm.

Further, in step S2, the homogenization comprises holding the original aluminum alloy cast ingot at a temperature of 490-560° C. for 8-16 hours; the length cut by the head and tail cutting is 100-150 mm, and the depth of the skin turning is 5-15 mm.

Further, in step S3, the rapid solidification treatment is carried out in a belt spinner, and the melting chamber of the belt spinner is filled with an inert gas, with a melt temperature of 780-850° C.

Further, in step S3, the rotational linear speed of the copper cooling roller for the rapid solidification treatment is 10-40 m/s, preferably the cooling water flow rate is 1,000-4,000 L/h.

Further, in step S3, the pressure difference of the nozzle of the belt spinner is 15-30 kPa, and the liquid outflow width of the nozzle is 2.0-30.0 mm.

Further, in step S4, the cold pressing is carried out in a cold pressing mold, with a holding pressure of 100-300 MPa and a pressure holding time of 20-600 seconds.

Further, in step S5, the extrusion cylinder temperature of the hot extrusion is 350-470° C., the heating temperature of the cold pressed blank is 350-560° C., and the temperature holding time is 20-60 minutes;
and/or, the extrusion mold temperature of the hot extrusion is 300-500° C., the total extrusion ratio is 4-30, and the extrusion speed is ≤6 m/min.

Further, in step S6, the temperature of the solution treatment is 510-570° C. and the time is 30-120 minutes;
and/or, the temperature of the aging treatment is 150-200° C. and the time is 1-8 hours.

According to another aspect of the present disclosure, an optical aluminum alloy is provided, which is prepared by any of the aforementioned preparation methods.

By applying the technical solution of the present disclosure and utilizing rapid solidification technology, the grain structure can be significantly refined, composition segregation can be reduced, and micron-sized microscopic grain structures can be obtained, which can be used for processing a highly flat surface. In addition, hot extrusion of the cold pressed raw blank prepared from the rapid solidification strips can ensure the compactness and uniform refinement of grain structure of the finished bar, which plays an important role in improving the surface state of the optical aluminum alloy finished products. The present disclosure adopts the technical route of “melt spinning-cold pressing-hot extrusion”, which can obtain aluminum alloy materials with uniform composition, uniform grain structure, and uniform dispersion of nanoprecipitated phase. The surface roughness of the optical aluminum alloy prepared by the present disclosure after precision machining can reach Ra of 3.0 nm or less, increasing the optical reflectivity, and having excellent tensile strength and hardness.

### BRIEF DESCRIPTION OF THE DRAWINGS

The accompanying drawings of the description, which form a part of the application, are used to provide a further understanding of the disclosure. The illustrative embodiments and their descriptions of the disclosure are used to explain the disclosure, and do not constitute an improper limitation thereto. In the accompanying drawings:

FIG. 1 shows a process flow diagram of the preparation method in Example 1 of the present disclosure;

FIG. 2 shows a rapid solidification alloy strip sample prepared in Example 1 of the present disclosure;

FIG. 3 shows the microstructure of the rapid solidification alloy strip prepared in Example 1 of the present disclosure;

FIG. 4 shows the transmission electron microscopy (TEM) structure of the rapid solidification alloy strip prepared in Example 1 of the present disclosure;

FIG. 5 shows the transmission electron microscopy (TEM) structure of the rapid solidification alloy strip prepared in Example 4 of the present disclosure;

FIG. 6 shows the finished material sample prepared in Example 1 of the present disclosure;

FIG. 7 shows the metallographic structure of the optical aluminum alloy material prepared in Example 1 of the present disclosure;

FIG. 8 shows the metallographic structure of the optical aluminum alloy material prepared in Example 19 of the present disclosure;

FIG. 9 shows the low magnification (50×) grain structure of the finished material prepared in Example 2 of the present disclosure;

FIG. 10 shows the high magnification (500×) grain structure of the finished material prepared in Example 2 of the present disclosure;

FIG. 11 shows the vertical sectional SEM structure of the finished material in Example 1 of the present disclosure;

FIG. 12 shows the vertical sectional SEM structure of the finished material in Example 20 of the present disclosure;

FIG. 13 shows the surface roughness test results of the finished material prepared in Example 5 of the present disclosure after single point diamond turning.

### DETAILED DESCRIPTION OF THE EMBODIMENTS

It should be noted that the examples and features in the examples in the present application can be combined with each other without conflicting. The present disclosure will be described in detail below with reference to the drawings and in combination with examples.

Theoretical researches have shown that the optical reflectivity of aluminum alloy materials is mainly related to the surface smoothness of the alloy material, and the magnitude of the surface smoothness mainly depends on the matrix structure morphology, grain morphology and size of the alloy material, as well as the uniformity of the second phase particle distribution. Rapid solidification is a non-equilibrium solidification process that directly condenses liquid materials into solid instantaneously at a cooling rate greater than 10⁴-10⁶ K/s, generally generating noncrystalline, quasicrystalline, microcrystalline, or nanocrystalline, etc., and a material with special properties and applications can be obtained. In the prior art, there is a problem of low optical surface reflectivity or high cost of optical aluminum alloy materials. In order to solve this problem, the present application provides an optical aluminum alloy and a preparation method thereof, which uses a rapid solidification process to prepare an optical aluminum alloy material with high optical reflectivity.

According to a typical embodiment of the present application, a preparation method of the optical aluminum alloy is provided, and the preparation method includes the following steps: step S1, preparing an original aluminum alloy cast ingot from raw materials by adopting a semi-continuous casting process, wherein the semi-continuous casting process includes subjecting the raw materials to heating melting, alloying, refining, slagging-off, standing, degassing, filtering and semi-continuous water-cooling casting; step S2, subjecting the original aluminum alloy cast ingot to homogenization, head and tail cutting and skin turning, to obtain a surface treated alloy raw material; step S3, subjecting the surface treated alloy raw material to rapid solidification treatment through a melt spinning method to obtain a rapid solidification alloy strip; step S4: subjecting the rapid solidification alloy strip to crushing treatment and then to sheathing and cold pressing, to obtain a cold pressed blank; step S5, subjecting the cold pressed blank to 1-2 passes of hot extrusion procedures to prepare a bar; and step S6, subjecting the bar to solution treatment and aging treatment, to obtain the finished aluminum alloy material.

A rapid solidification technology is used in the present application, which can significantly refine the grain structure and reduce composition segregation, so that micron-sized microscopic grain structures can be obtained, which can be used for processing a highly flat surface. In addition, hot extrusion of the cold pressed raw blank prepared from the rapid solidification strips can ensure the compactness and uniform refinement of grain structure of the finished bar, which plays an important role in improving the surface state of the optical aluminum alloy finished products. The present disclosure adopts the technical route of “melt spinning-cold pressing-hot extrusion”, which can obtain finished aluminum alloy materials with uniform composition, uniform grain structure, and uniform dispersion of nanoprecipitated phase. The surface roughness of the optical aluminum alloy prepared by the present disclosure after precision machining can reach Ra of 3.0 nm or less, increasing the optical reflectivity, and having excellent tensile strength and hardness.

In some typical embodiments of the present application, the aforementioned original aluminum alloy cast ingot comprises the following components: a content of 0.40%-0.80% of Si, a content of ≤0.10% of Fe, a content of 0.15%-0.40% of Cu, a content of ≤0.10% of Mn, a content of 0.80%-1.20% of Mg, a content of 0.15%-0.30% of Cr, a content of ≤0.05% of Ni, a content of ≤0.25% of Zn, a content of 0.05%-0.15% of Ti, a content of 0.02%-0.04% of Zr, a content of ≤0.03% of V, a content of 0%-0.20% of Sc, with the balance being Al and impurities, the total amount of impurities being less than 0.15% and the content of each impurity element being less than 0.05%, all of which are in terms of mass percentage.

By designing the composition of the optical aluminum alloy materials, strictly reducing the content of impurity element Fe, and improving the purity of the aluminum alloy melt, the volume of insoluble Fe phase in the aluminum matrix can be effectively reduced, which can prevent the increase in surface roughness caused by bulky second phases during the high-precision surface processing of the finished materials, and ensure the surface smoothness of the optical aluminum materials. On the other hand, on the basis of compositions of conventional Al—Mg—Si series aluminum alloy materials, the composition content of Si and Mg main alloy elements is optimized, the atomic ratio and size of the precipitated phase are controlled, and the size stability of the nanoprecipitated phase of the finished materials is ensured. In addition, precise control of Mn element content is conducive to promoting the transformation of the alloy from AlFeSi phase to AlFeMnSi phase. On this basis, trace alloying elements such as Cr, Ti, Zr, etc., are added to improve the surface activity between alloy phase boundaries and the hardness of the aluminum matrix, thereby enhancing the finished product rate of mirror precision machining of the material.

In some embodiments of the present application, the Fe content in the aforementioned original aluminum alloy cast ingot is ≤0.08% in terms of mass percentage; in some embodiments of the present application, the Fe content in the aforementioned original aluminum alloy cast ingot is ≤0.06% in terms of mass percentage; and in some embodiments of the present application, the Fe content in the aforementioned original aluminum alloy cast ingot is ≤0.04% in terms of mass percentage.

In the aforementioned original aluminum alloy cast ingot, the content of Si can be listed as 0.40%, 0.45%, 0.50%, 0.55%, 0.60%, 0.65%, 0.70%, 0.75%, 0.80%, in terms of mass percentage, or a range between any two of above.

In the aforementioned original aluminum alloy cast ingot, the content of Mg can be listed as 0.80%, 0.85%, 0.90%, 0.95%, 1.00%, 1.05%, 1.10%, 1.15%, 1.20%, in terms of mass percentage, or a range between any two of above.

In the aforementioned original aluminum alloy cast ingot, the content of Cr can be listed as 0.15%, 0.20%, 0.25%, 0.30%, in terms of mass percentage, or a range between any two of above.

In the aforementioned original aluminum alloy cast ingot, the content of Zr can be listed as 0.02%, 0.025%, 0.03%, 0.035%, 0.04%, in terms of mass percentage, or a range between any two of above.

In some embodiments of the present application, the content of Mn in the aforementioned original aluminum alloy cast ingot is ≤0.09% in terms of mass percentage; in some embodiments of the present application, the Mn content in the aforementioned original aluminum alloy cast ingot is ≤0.07% in terms of mass percentage; in some embodiments of the present application, the Mn content in the aforementioned original aluminum alloy cast ingot is ≤0.06% in terms of mass percentage; and in some embodiments of the present application, the Mn content in the aforementioned original aluminum alloy cast ingot is ≤0.04% in terms of mass percentage.

In the aforementioned original aluminum alloy cast ingot, the content of Sc can be listed as 0%, 0.02%, 0.04%, 0.06%, 0.08%, 0.10%, 0.12%, 0.14%, 0.16%, 0.18%, 0.20%, in terms of mass percentage, or a range between any two of above. The raw materials used for semi-continuous casting can selected as corresponding metal elements or alloys according to the composition of the alloy. In some typical embodiments of the present application, the raw materials include 99.9% of industrial pure aluminum, industrial pure magnesium, aluminum copper interalloy, aluminum zirconium interalloy, aluminum silicon interalloy, aluminum manganese interalloy, aluminum chromium interalloy, industrial pure zinc, aluminum titanium interalloy, aluminum vanadium interalloy, and aluminum scandium interalloy.

In some embodiments of the present application, the melt temperature of the aforementioned alloy raw materials is 730-770° C. In some embodiments of the present application, the temperature of the molten aluminum in the crystallizer for semi-continuous casting is 675-695° C., and preferably the casting speed of the semi-continuous water-cooling casting is 20-50 mm/min, and the diameter of the obtained original aluminum alloy cast ingot is 80-400 mm.

In some embodiments of the present application, the aforementioned filtration is carried out using a two-stage ceramic filter, with a first stage filter of the two-stage ceramic filter having a pore size of 35-45 mesh and a second stage filter having a pore size of 55-65 mesh, the filtering effect is good, which is conducive to improving the surface smoothness of the final aluminum alloy product.

In some typical embodiments of the present application, in step S2, the homogenization includes holding the original aluminum alloy cast ingot at a temperature of 490-560° C. for 8-16 hours, which has a good homogenization effect on the aluminum alloy of the present application. In some embodiments of the present application, the length cut by the head and tail cutting is 100-150 mm, and the depth of the skin turning is 5-15 mm.

The above “rapid solidification” refers to the rapid decrease in temperature when the molten alloy raw material comes into contact with a rapidly rotating cooling wheel, resulting in a metal strip, then subjecting the resulting metal strip to subsequent densification processing, to obtain a micron-sized microscopic grain structure, which can be used for processing a highly flat surface.

In some embodiments of the present application, in step S3, the rapid solidification treatment is carried out in a belt spinner, and the melting chamber of the belt spinner is filled with inert gas, with a melt temperature of 780-850° C., which can improve the surface smoothness of the finished aluminum alloy, so that a rapid solidification strip with smoother surface and more uniform thickness can be prepared. The aforementioned inert gas can be listed as any one or more of nitrogen, argon, and helium. In some embodiments of the present application, the vacuum degree of the melting chamber of the belt spinner is first set to 2×10⁻³ to 5×10⁻³ Pa, and then argon is introduced into the melting chamber for protection, the melting chamber is ensured at a certain argon concentration to further improve the surface smoothness of the aluminum alloy.

In some embodiments of the present application, in step S3, the rotational linear speed of the copper cooling roller for the rapid solidification treatment is 10-40 m/s, preferably the cooling water flow rate is 1,000-4,000 L/h. By selecting an appropriate rotational linear speed and cooling water flow rate of the cooling roller, the surface smoothness and thickness uniformity of the rapid solidification strip are further improved. Preferably, the pressure difference of the nozzle of the belt spinner is 15-30 kPa, and the liquid outflow width of the nozzle is 2.0-30.0 mm, which has a significant effect on obtaining a rapid solidification alloy strip with smooth surface and uniform thickness.

In some embodiments of the present application, in the above step S3, the thickness of the prepared strip is 15-100 μm, the width of the strip is 2.0-30.0 mm, and the cooling rate is high during the preparation process, which is conducive to obtaining aluminum alloy materials with better performance.

In some typical embodiments of the present application, the above step S4 includes: crushing the rapid solidification alloy strip using a shearing machine, cleaning same with alcohol ultrasonic cleaning and oven-drying, then placing into a pre-made sheath, and cold pressing in a cold pressing mold using a press. In some embodiments of the present application, the cold pressing is carried out in a cold pressing mold with a holding pressure of 100-300 MPa and a pressure holding time of 20-600 seconds, which is conducive to improving the compactness of the cold pressed blank, reducing porosity and air-pore defects, and thereby improving the surface smoothness of the finished optical aluminum alloy product. In some embodiments of the present application, the obtained cold pressed raw blank is of D 150-400 mm.

In some preferred embodiments of the present application, in the above step S5, the extrusion cylinder temperature of the hot extrusion is 300-500° C., the heating temperature of the cold pressed blank is 400-500° C., and the temperature holding time is 20-60 minutes; the extrusion mold temperature of the hot extrusion is 300-500° C., the total extrusion ratio is 4-30, and the extrusion speed is ≤6 m/min. By reasonable control of extrusion temperature and extrusion ratio, the compactness and uniform refinement of grain structure of the finished bar are further promoted, which has a significant effect on improving the surface state of the finished optical aluminum alloy products and increasing the optical reflectivity. In some embodiments of the present application, an extruded bar with (20-120 mm is obtained by hot extrusion.

In the above step S6, in order to further improve the comprehensive performance of the finished aluminum alloy material, preferably the temperature of the solution treatment is 510-570° C. and the time is 30-120 minutes. In some embodiments of the present application, the temperature of the aging treatment is 150-200° C. and the time is 1-8 hours, which can provide a better control of the grain size of the finished material and the mechanical properties of the alloy.

According to another typical embodiment of the present application, an optical aluminum alloy is provided, which is prepared by any of the aforementioned preparation methods.

The optical aluminum alloy obtained by the above method in the present application has excellent surface processing performance by effectively controlling key indicators such as grain size, recrystallization volume fraction, precipitation phase size and distribution, and mechanical properties, etc. of the finished material, and optical aluminum alloy materials with a surface roughness of less than Ra=3 nm can be obtained by means of single point diamond precision turning, and precision polishing technology, etc.

The beneficial effects that can be realized in the application will be further explained below in combination with the examples and the comparative examples.

### Example 1

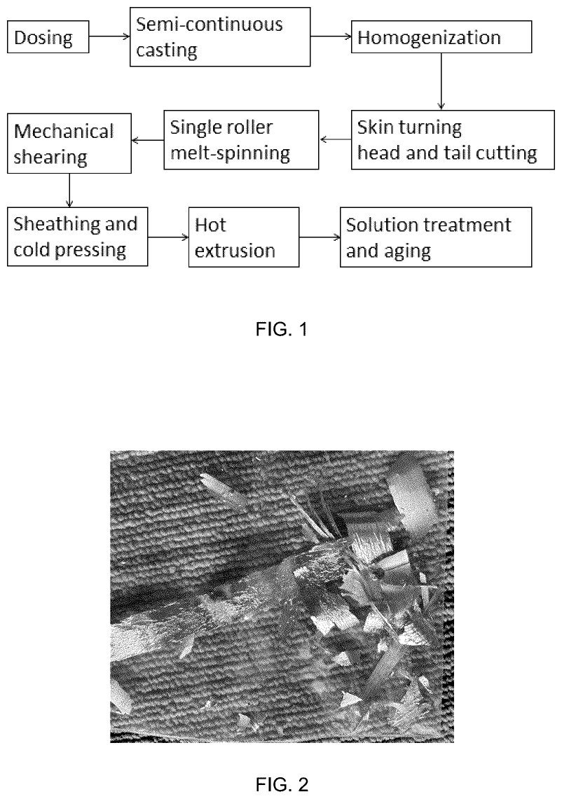

The process flow diagram of the preparation method of the optical aluminum alloy is as shown in FIG. 1.

The alloy raw materials included the following components in terms of mass percentage: 0.67% of Si, 0.075% of Fe, 0.30% of Cu, 0.084% of Mn, 0.90% of Mg, 0.21% of Cr, 0.03% of Ni, 0.11% of Zn, 0.086% of Ti, 0.028% of Zr, 0.013% of V, 0% of Sc, with balance of Al and impurities. The above raw materials were used for dosing, followed by performing heating melting, alloying, refining, slagging-off, standing, degassing, filtering and semi-continuous water-cooling casting to obtain the original aluminum alloy cast ingot, wherein the melt temperature was 740° C., the temperature of the molten aluminum in the crystallizer was 695° C., the diameter of the cast ingot was of Φ178 mm, and the casting speed was 30 mm/min; a two-stage ceramic filter was used for filtration, with a mesh size of filter of 45 mesh and 55 mesh, respectively; the alloy ingot was subjected to homogenization at 560° C. for 8 hours, and added to a single roller belt spinner after 10 mm of the skin turning and head and tail cutting, i.e. single roller melt-spinning for preparation of rapid solidification strip, where the vacuum degree of the melting chamber was 2×10⁻³ Pa, and argon was introduced for protection; the melt temperature was 800° C., the rotational linear speed of the copper cooling roller was 17 m/s, the cooling water flow rate was 2,000 L/h, the pressure difference of the nozzle was 20 kPa, the liquid outflow width was 10.0 mm, the thickness of the prepared strip was 40-60 μm, and the width of the strip was 7.0-16.0 mm; the alloy strip was mechanically sheared, cleaned with alcohol and oven-dried, then subjected to sheathing and cold pressing, with a holding pressure of 200 MPa and a pressure holding time of 30 seconds to prepare a cold pressed blank of Φ 250 mm; the cold pressed blank was subjected to 1 pass of hot extrusion with an extrusion cylinder temperature of 400° C., a heating temperature of 490° C. for the raw blank, and a temperature holding time of 30 minutes; the temperature of the extrusion mold was 450° C., the extrusion ratio was 17.4, and the extrusion speed was 3 m/min, so that an extruded bar of Φ 60 mm was obtained; finally, the bar material was subjected to solution treatment and aging treatment, with a solution temperature of 530° C. and a solution time of 60 minutes, an aging temperature of 175° C. and an aging time of 2 hours.

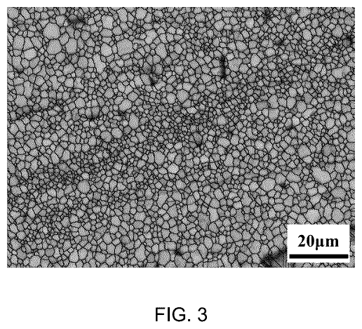

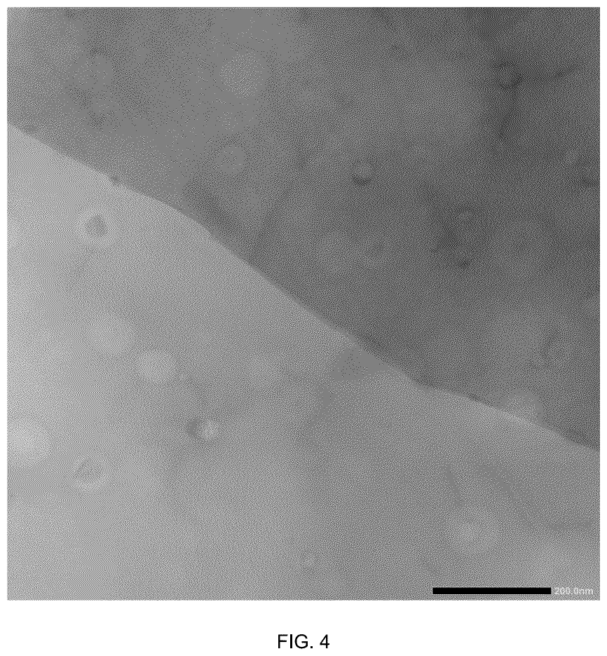

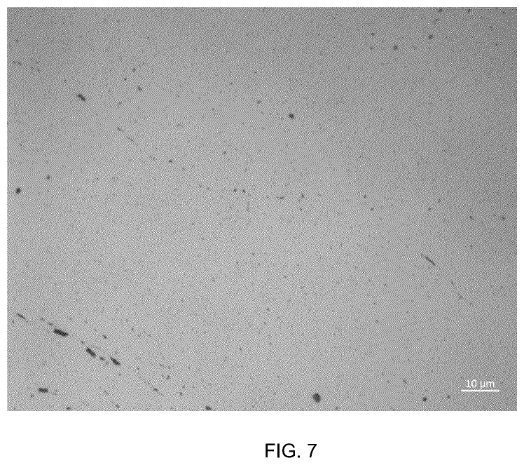

The rapid solidification alloy strip formed during the preparation process is as shown in the photograph of FIG. 2, the microstructure is as shown in FIG. 3, and the TEM structure is as shown in FIG. 4; the finished optical aluminum alloy material obtained through the above treatments is as shown in FIG. 6, the metallographic structure is as shown in FIG. 7, and the vertical sectional SEM structure is as shown in FIG. 11.

### Example 2

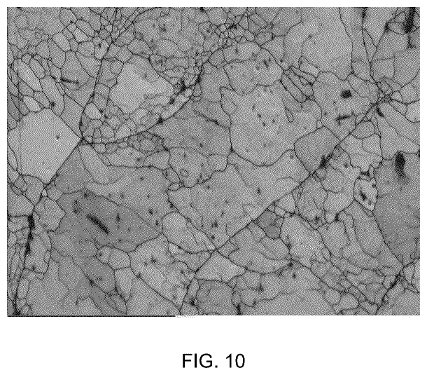

The preparation method of the optical aluminum alloy, the alloy raw materials included the following components in terms of mass percentage: 0.63% of Si, 0.077% of Fe, 0.30% of Cu, 0.083% of Mn, 0.85% of Mg, 0.22% of Cr, 0.03% of Ni, 0.11% of Zn, 0.078% of Ti, 0.033% of Zr, 0.015% of V, 0% of Sc, with balance of Al and impurities. The raw materials were subjected to heating melting, alloying, refining, slagging-off, standing, degassing, filtering and semi-continuous water-cooling casting to obtain the original aluminum alloy cast ingot, wherein the melt temperature was 750° C., the temperature of the molten aluminum in the crystallizer was 700° C., the diameter of the cast ingot was of D254 mm, and the casting speed was 25 mm/min; a two-stage ceramic filter was used for filtration, with a mesh size of filter of 45 mesh and 55 mesh, respectively; the alloy ingot was subjected to homogenization at 530° C. for 16 hours, and added to a single roller belt spinner after 10 mm of the head and tail cutting and skin turning for preparation of rapid solidification strip, where the vacuum degree of the melting chamber was 3×10⁻³ Pa, and argon was introduced for protection; the melt temperature was 810° C., the rotational linear speed of the copper cooling roller was 30 m/s, the cooling water flow rate was 3,500 L/h, the pressure difference of the nozzle was 20 kPa, the liquid outflow width was 10.0 mm, the thickness of the prepared strip was 40-60 μm, and the width of the strip was 7.0-16.0 mm; the alloy strip was crushed, cleaned with alcohol and oven-dried, then subjected to sheathing and cold pressing, with a holding pressure of 200 MPa and a pressure holding time of 40 seconds to prepare a cold pressed blank of Φ 150 mm; the cold pressed blank was subjected to 1 pass of hot extrusion with an extrusion cylinder temperature of 400° C., a heating temperature of 450° C. for the raw blank, and a temperature holding time of 30 minutes; the temperature of the extrusion mold was 450° C., the extrusion ratio was 9, and the extrusion speed was 4 m/min, so that an extruded bar of Φ 50 mm was obtained; finally, the bar material was subjected to solution treatment and aging treatment, with a solution temperature of 530° C. and a solution time of 60 minutes, an aging temperature of 175° C. and an aging time of 2 hours. The low magnification (50×) and high magnification (500×) grain structures of the finished material in this example are as shown in FIGS. 9 and 10, respectively.

### Example 3

The preparation method of the optical aluminum alloy, the alloy raw materials included the following components in terms of mass percentage: 0.71% of Si, 0.068% of Fe, 0.34% of Cu, 0.085% of Mn, 0.86% of Mg, 0.22% of Cr, 0.015% of Ni, 0.11% of Zn, 0.02% of Ti, 0.02% of Zr, 0.015% of V, 0.02% of Sc, with balance of Al and impurities. The raw materials were subjected to heating melting, alloying, refining, slagging-off, standing, degassing, filtering and semi-continuous water-cooling casting to obtain the original aluminum alloy cast ingot, wherein the melt temperature was 740° C., the temperature of the molten aluminum in the crystallizer was 695° C., the diameter of the cast ingot was of D254 mm, and the casting speed was 20 mm/min; a two-stage ceramic filter was used for filtration, with a mesh size of filter of 45 mesh and 55 mesh, respectively; the alloy ingot was subjected to homogenization at 560° C. for 8 hours, and added to a single roller belt spinner i.e. single roller melt-spinning after 10 mm of the head and tail cutting and skin turning for preparation of rapid solidification strip, where the vacuum degree of the melting chamber was 2×10⁻³ Pa, and argon was introduced for protection; the melt temperature was 820° C., the rotational linear speed of the copper cooling roller was 17 m/s, the cooling water flow rate was 2,000 L/h, the pressure difference of the nozzle was 20 kPa, the liquid outflow width was 10.0 mm, the thickness of the prepared strip was 40-60 μm, and the width of the strip was 7.0-16.0 mm; the alloy strip was mechanically sheared, cleaned with alcohol and oven-dried, then subjected to sheathing and cold pressing, with a holding pressure of 200 MPa and a pressure holding time of 30 seconds to prepare a cold pressed blank of Φ 240 mm; the cold pressed blank was subjected to 1 pass of hot extrusion with an extrusion cylinder temperature of 420° C., a heating temperature of 530° C. for the raw blank, and a temperature holding time of 30 minutes; the temperature of the extrusion mold was 480° C., the extrusion ratio was 16, and the extrusion speed was 1.5 m/min, so that an extruded bar of Φ 60 mm was obtained; finally, the bar material was subjected to solution treatment and aging treatment, with a solution temperature of 560° C. and a solution time of 90 minutes, an aging temperature of 175° C. and an aging time of 2 hours.

### Example 4

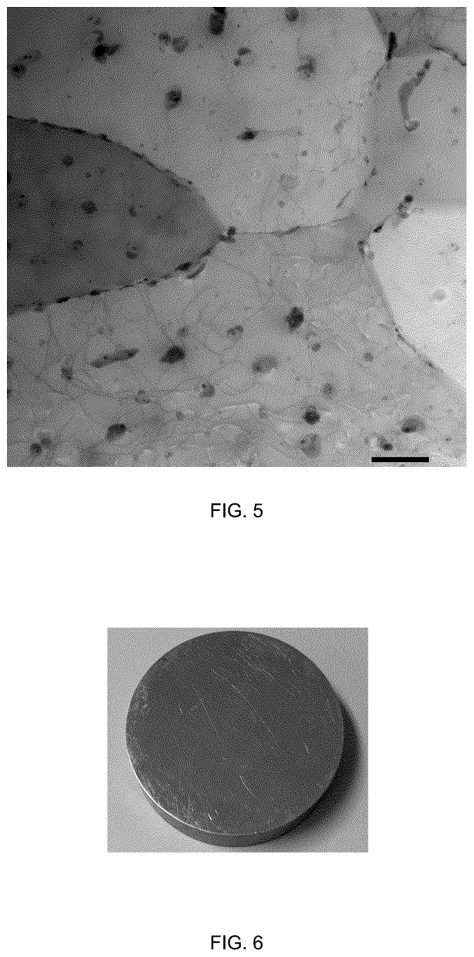

The preparation method of the optical aluminum alloy, the alloy raw materials included the following components in terms of mass percentage: 0.69% of Si, 0.072% of Fe, 0.32% of Cu, 0.089% of Mn, 0.83% of Mg, 0.20% of Cr, 0.01% of Ni, 0.10% of Zn, 0.01% of Ti, 0.03% of Zr, 0.01% of V, 0.13% of Sc, with balance of Al and impurities. The raw materials were subjected to heating melting, alloying, refining, slagging-off, standing, degassing, filtering and semi-continuous water-cooling casting to obtain the original aluminum alloy cast ingot, wherein the melt temperature was 740° C., the temperature of the molten aluminum in the crystallizer was 695° C., the diameter of the cast ingot was of D254 mm, and the casting speed was 20 mm/min; a two-stage ceramic filter was used for filtration, with a mesh size of filter of 45 mesh and 55 mesh, respectively; the alloy ingot was subjected to homogenization at 540° C. for 8 hours, and added to a single roller belt spinner i.e. single roller melt-spinning after 10 mm of the head and tail cutting and skin turning for preparation of rapid solidification strip, where the vacuum degree of the melting chamber was 2×10⁻³ Pa, and argon was introduced for protection; the melt temperature was 830° C., the rotational linear speed of the copper cooling roller was 17 m/s, the cooling water flow rate was 2000 L/h, the pressure difference of the nozzle was 20 kPa, the liquid outflow width was 10.0 mm, the thickness of the prepared strip was 40-60 μm, and the width of the strip was 7.0-16.0 mm, the TEM structure of which was as shown in FIG. 5; the alloy strip was mechanically sheared, cleaned with alcohol and oven-dried, then subjected to sheathing and cold pressing, with a holding pressure of 200 MPa and a pressure holding time of 30 seconds to prepare a cold pressed blank of Φ 240 mm; the cold pressed blank was subjected to 1 pass of hot extrusion with an extrusion cylinder temperature of 420° C., a heating temperature of 530° C. for the raw blank, and a temperature holding time of 30 minutes; the temperature of the extrusion mold was 480° C., the extrusion ratio was 16, and the extrusion speed was 1.5 m/min, so that an extruded bar of Φ 60 mm was obtained; finally, the bar material was subjected to solution treatment and aging treatment, with a solution temperature of 560° C. and a solution time of 90 minutes, an aging temperature of 175° C. and an aging time of 2 hours.

### Example 5

The preparation method of the optical aluminum alloy, the alloy raw materials included the following components in terms of mass percentage: 0.76% of Si, 0.079% of Fe, 0.33% of Cu, 0.077% of Mn, 0.84% of Mg, 0.22% of Cr, 0.01% of Ni, 0.10% of Zn, 0.04% of Ti, 0.026% of Zr, 0.01% of V, 0.01% of Sc, with balance of Al and impurities. The raw materials were subjected to heating melting, alloying, refining, slagging-off, standing, degassing, filtering and semi-continuous water-cooling casting to obtain the original aluminum alloy cast ingot, wherein the melt temperature was 740° C., the temperature of the molten aluminum in the crystallizer was 695° C., the diameter of the cast ingot was of D254 mm, and the casting speed was 20 mm/min; a two-stage ceramic filter was used for filtration, with a mesh size of filter of 45 mesh and 55 mesh, respectively; the alloy ingot was subjected to homogenization at 560° C. for 8 hours, and added to a single roller belt spinner i.e. single roller melt-spinning after 10 mm of the head and tail cutting and skin turning for preparation of rapid solidification strip, where the vacuum degree of the melting chamber was 2×10⁻³ Pa, and argon was introduced for protection; the melt temperature was 810° C., the rotational linear speed of the copper cooling roller was 23 m/s, the cooling water flow rate was 2,500 L/h, the pressure difference of the nozzle was 18 kPa, the liquid outflow width was 23.0 mm, the thickness of the prepared strip was 40-80 μm, and the width of the strip was 15.0-28.0 mm; the alloy strip was mechanically sheared, cleaned with alcohol and oven-dried, then subjected to sheathing and cold pressing, with a holding pressure of 120 MPa and a pressure holding time of 30 seconds to prepare a cold pressed blank of Φ 405 mm; the cold pressed blank was subjected to 2 passes of hot extrusion with an extrusion cylinder temperature of 300° C. for pass 1, a heating temperature of 350° C. for the raw blank, and a temperature holding time of 30 minutes; the temperature of the extrusion mold was 300° C., the extrusion ratio was 2.62, and the extrusion speed was 0.5 m/min, so that an extruded bar of Φ 250 mm was obtained; an extrusion cylinder temperature of 420° C. for pass 2, a heating temperature of 520° C. for the raw blank, and a temperature holding time of 30 minutes; the temperature of the extrusion mold was 450° C., the extrusion ratio was 6.25, and the extrusion speed was 1.2 m/min, so that an extruded bar of Φ 100 mm was obtained; finally, the bar material was subjected to solution treatment and aging treatment, with a solution temperature of 560° C. and a solution time of 90 minutes, an aging temperature of 175° C. and an aging time of 2 hours.

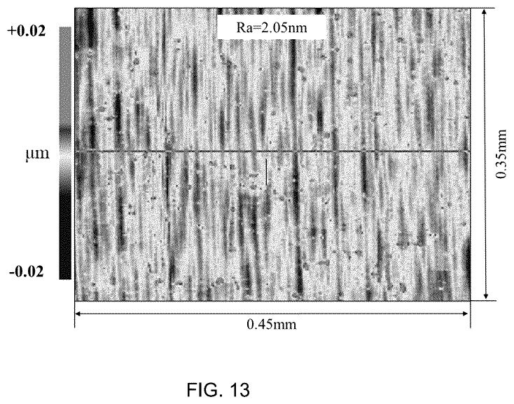

The surface roughness test results of the finished material obtained after single point diamond turning are as shown in FIG. 13.

### Example 6

The preparation method of the optical aluminum alloy, the alloy raw materials included the following components in terms of mass percentage: 0.63% of Si, 0.077% of Fe, 0.30% of Cu, 0.083% of Mn, 0.85% of Mg, 0.22% of Cr, 0.03% of Ni, 0.11% of Zn, 0.078% of Ti, 0.033% of Zr, 0.015% of V, 0% of Sc, with balance of Al and impurities. The raw materials were subjected to heating melting, alloying, refining, slagging-off, standing, degassing, filtering and semi-continuous water-cooling casting to obtain the original aluminum alloy cast ingot, wherein the melt temperature was 750° C., the temperature of the molten aluminum in the crystallizer was 700° C., the diameter of the cast ingot was of D254 mm, and the casting speed was 25 mm/min; a two-stage ceramic filter was used for filtration, with a mesh size of filter of 45 mesh and 55 mesh, respectively; the alloy ingot was subjected to homogenization at 560° C. for 12 hours, and added to a single roller belt spinner after 10 mm of the head and tail cutting and skin turning for preparation of rapid solidification strip, where the vacuum degree of the melting chamber was 3×10⁻³ Pa, and argon was introduced for protection; the melt temperature was 810° C., the rotational linear speed of the copper cooling roller was 30 m/s, the cooling water flow rate was 3,500 L/h, the pressure difference of the nozzle was 20 kPa, the liquid outflow width was 10.0 mm, the thickness of the prepared strip was 40-60 μm, and the width of the strip was 7.0-16.0 mm; the alloy strip was crushed, cleaned with alcohol and oven-dried, then subjected to sheathing and cold pressing, with a holding pressure of 200 MPa and a pressure holding time of 40 seconds to prepare a cold pressed blank of Φ 150 mm; the cold pressed blank was subjected to 1 pass of hot extrusion with an extrusion cylinder temperature of 400° C., a heating temperature of 450° C. for the raw blank, and a temperature holding time of 30 minutes; the temperature of the extrusion mold was 450° C., the extrusion ratio was 9, and the extrusion speed was 4 m/min, so that an extruded bar of Φ 50 mm was obtained; finally, the bar material was subjected to solution treatment and aging treatment, with a solution temperature of 530° C. and a solution time of 60 minutes, an aging temperature of 175° C. and an aging time of 6 hours.

### Example 7

The preparation method of the optical aluminum alloy, the alloy raw materials included the following components in terms of mass percentage: 0.67% of Si, 0.075% of Fe, 0.30% of Cu, 0.084% of Mn, 0.90% of Mg, 0.21% of Cr, 0.03% of Ni, 0.11% of Zn, 0.086% of Ti, 0.028% of Zr, 0.013% of V, 0% of Sc, with balance of Al and impurities. The raw materials were subjected to heating melting, alloying, refining, slagging-off, standing, degassing, filtering and semi-continuous water-cooling casting to obtain the original aluminum alloy cast ingot, wherein the melt temperature was 750° C., the temperature of the molten aluminum in the crystallizer was 700° C., the diameter of the cast ingot was of D254 mm, and the casting speed was 25 mm/min; a two-stage ceramic filter was used for filtration, with a mesh size of filter of 45 mesh and 55 mesh, respectively; the alloy ingot was subjected to homogenization at 530° C. for 16 hours, and added to a single roller belt spinner after 10 mm of the head and tail cutting and skin turning for preparation of rapid solidification strip, where the vacuum degree of the melting chamber was 3×10⁻³ Pa, and argon was introduced for protection; the melt temperature was 810° C., the rotational linear speed of the copper cooling roller was 15 m/s, the cooling water flow rate was 2000 L/h, the pressure difference of the nozzle was 20 kPa, the liquid outflow width was 10.0 mm, the thickness of the prepared strip was 40-60 μm, and the width of the strip was 7.0-16.0 mm; the alloy strip was crushed, cleaned with alcohol and oven-dried, then subjected to sheathing and cold pressing, with a holding pressure of 200 MPa and a pressure holding time of 40 seconds to prepare a cold pressed blank of Φ 150 mm; the cold pressed blank was subjected to 1 pass of hot extrusion with an extrusion cylinder temperature of 400° C., a heating temperature of 450° C. for the raw blank, and a temperature holding time of 30 minutes; the temperature of the extrusion mold was 450° C., the extrusion ratio was 9, and the extrusion speed was 4 m/min, so that an extruded bar of Φ 50 mm was obtained; finally, the bar material was subjected to solution treatment and aging treatment, with a solution temperature of 530° C. and a solution time of 60 minutes, an aging temperature of 175° C. and an aging time of 2 hours.

### Example 8

The difference between Example 8 and Example 1 lied in that the alloy ingot was subjected to homogenization at 430° C. for 8 hours.

### Example 9

The difference between Example 9 and Example 1 lied in that the content of Si by mass percentage in the alloy raw material was 0.3%.

### Example 10

The difference between Example 10 and Example 1 lied in that the content of Si by mass percentage in the alloy raw material was 1.0%.

### Example 11

The difference between Example 11 and Example 1 lied in that the content of Mg by mass percentage in the alloy raw material was 0.5%.

### Example 12

The difference between Example 12 and Example 1 lied in that the content of Mg by mass percentage in the alloy raw material was 1.5%.

### Example 13

The difference between Example 13 and Example 1 lied in that the alloy raw material contained no Zr.

### Example 14

The difference between Example 14 and Example 1 lied in that the pressure difference of the nozzle was 30 kPa.

### Example 15

The difference between Example 15 and Example 1 lied in that the pressure difference of the nozzle was 15 kPa.

### Example 16

The difference between Example 16 and Example 1 lied in that the liquid outflow width was 5.0 mm.

### Example 17

The difference between Example 17 and Example 1 lied in that the liquid outflow width was 30.0 mm.

### Example 18

The difference between Example 18 and Example 1 lied in that the liquid outflow width was 35.0 mm.

### Example 19

The preparation method of the optical aluminum alloy, the alloy raw materials included the following components in terms of mass percentage: 0.69% of Si, 0.56% of Fe, 0.31% of Cu, 0.086% of Mn, 0.89% of Mg, 0.21% of Cr, 0.03% of Ni, 0.12% of Zn, 0.09% of Ti, 0.02% of Zr, 0.015% of V, 0% of Sc, with balance of Al and impurities. The raw materials were subjected to heating melting, alloying, refining, slagging-off, standing, degassing, filtering and semi-continuous water-cooling casting to obtain the original aluminum alloy cast ingot, wherein the melt temperature was 740° C., the temperature of the molten aluminum in the crystallizer was 695° C., the diameter of the cast ingot was of 0178 mm, and the casting speed was 30 mm/min; a two-stage ceramic filter was used for filtration, with a mesh size of filter of 45 mesh and 55 mesh, respectively; the alloy ingot was subjected to homogenization at 560° C. for 8 hours, and added to a single roller belt spinner after 10 mm of the head and tail cutting and skin turning, i.e. single roller melt-spinning for preparation of rapid solidification strip, where the vacuum degree of the melting chamber was 2×10⁻³ Pa, and argon was introduced for protection; the melt temperature was 800° C., the rotational linear speed of the copper cooling roller was 17 m/s, the cooling water flow rate was 2,000 L/h, the pressure difference of the nozzle was 20 kPa, the liquid outflow width was 10.0 mm, the thickness of the prepared strip was 40-60 μm, and the width of the strip was 7.0-16.0 mm; the alloy strip was mechanically sheared, cleaned with alcohol and oven-dried, then subjected to sheathing and cold pressing, with a holding pressure of 200 MPa and a pressure holding time of 30 seconds to prepare a cold pressed blank of Φ 250 mm; the cold pressed blank was subjected to 1 pass of hot extrusion with an extrusion cylinder temperature of 400° C., a heating temperature of 490° C. for the raw blank, and a temperature holding time of 30 minutes; the temperature of the extrusion mold was 450° C., the extrusion ratio was 17.4, and the extrusion speed was 3 m/min, so that an extruded bar of Φ 60 mm was obtained; finally, the bar material was subjected to solution treatment and aging treatment, with a solution temperature of 530° C. and a solution time of 60 minutes, an aging temperature of 175° C. and an aging time of 2 hours.

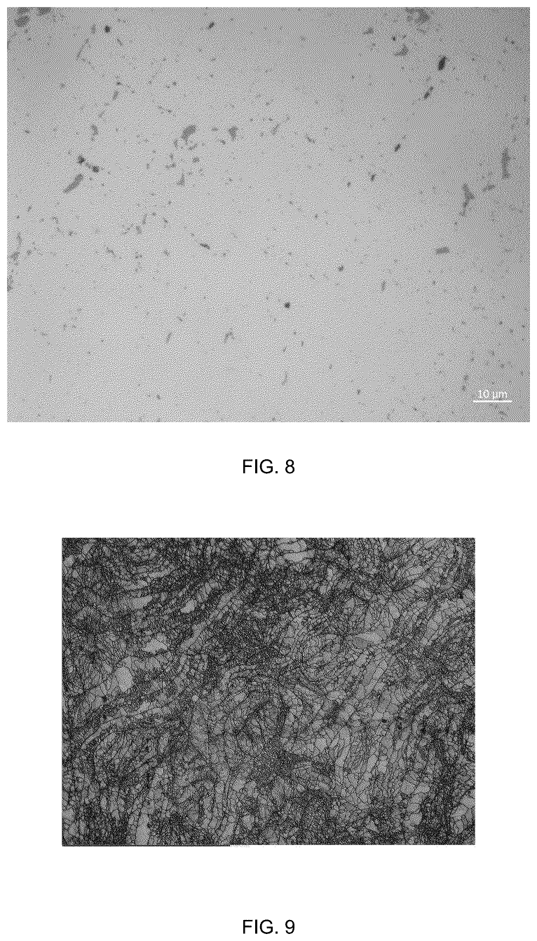

Compared with Example 1, the alloy raw material used was industrial pure aluminum, and the Fe content of the prepared alloy cast ingot was 0.56%, which was much higher than the Fe content (0.075%) of the alloy in Example 1. The cross-sectional metallographic structure of the prepared finished material is as shown in FIG. 8. It can be seen that there are many bulky Fe containing phases in the structure of the prepared finished material in this example, these Fe containing phases have larger sizes, which will reduce the uniformity of the materials.

### Example 20

The preparation method of the optical aluminum alloy, the alloy raw materials included the following components in terms of mass percentage: 0.76% of Si, 0.079% of Fe, 0.33% of Cu, 0.077% of Mn, 0.84% of Mg, 0.22% of Cr, 0.01% of Ni, 0.10% of Zn, 0.04% of Ti, 0.026% of Zr, 0.01% of V, 0.01% of Sc, with balance of Al and impurities. The raw materials were subjected to heating melting, alloying, refining, slagging-off, standing, degassing, filtering and semi-continuous water-cooling casting to obtain the original aluminum alloy cast ingot, wherein the melt temperature was 740° C., the temperature of the molten aluminum in the crystallizer was 695° C., the diameter of the cast ingot was of D254 mm, and the casting speed was 20 mm/min; a two-stage ceramic filter was used for filtration, with a mesh size of filter of 45 mesh and 55 mesh, respectively; the alloy ingot was subjected to homogenization at 560° C. for 8 hours, and added to a single roller belt spinner i.e. single roller melt-spinning after 10 mm of the head and tail cutting and skin turning for preparation of rapid solidification strip, where the vacuum degree of the melting chamber was 2×10⁻³ Pa, and argon was introduced for protection; the melt temperature was 810° C., the rotational linear speed of the copper cooling roller was 23 m/s, the cooling water flow rate was 2500 L/h, the pressure difference of the nozzle was 18 kPa, the liquid outflow width was 23.0 mm, the thickness of the prepared strip was 40-80 μm, and the width of the strip was 15.0-28.0 mm; the alloy strip was mechanically sheared, cleaned with alcohol and oven-dried, then subjected to sheathing and cold pressing, with a holding pressure of 120 MPa and a pressure holding time of 30 seconds to prepare a cold pressed blank of Φ 180 mm; the cold pressed blank was subjected to 1 pass of hot extrusion with an extrusion cylinder temperature of 300° C., a heating temperature of 450° C. for the raw blank, and a temperature holding time of 30 minutes; the temperature of the extrusion mold was 380° C., the extrusion ratio was 3.24, and the extrusion speed was 0.5 m/min, so that an extruded bar of Φ 100 mm was obtained; finally, the bar material was subjected to solution treatment and aging treatment, with a solution temperature of 560° C. and a solution time of 90 minutes, an aging temperature of 165° C. and an aging time of 2 hours.

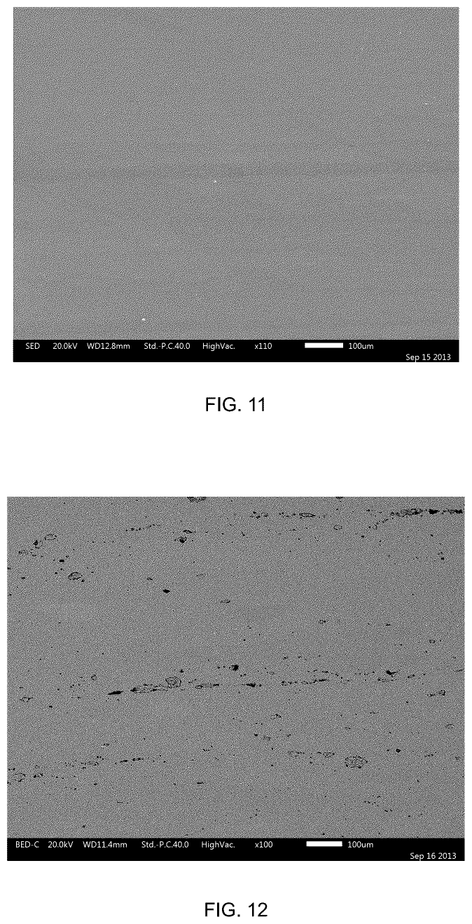

The vertical sectional SEM structure of the obtained finished material is as shown in FIG. 12.

### Example 21

The preparation method of the optical aluminum alloy, the alloy raw materials included the following components in terms of mass percentage: 0.63% of Si, 0.077% of Fe, 0.30% of Cu, 0.083% of Mn, 0.85% of Mg, 0.22% of Cr, 0.03% of Ni, 0.11% of Zn, 0.078% of Ti, 0.033% of Zr, 0.015% of V, 0% of Sc, with balance of Al and impurities. The raw materials were subjected to heating melting, alloying, refining, slagging-off, standing, degassing, filtering and semi-continuous water-cooling casting to obtain the original aluminum alloy cast ingot, wherein the melt temperature was 750° C., the temperature of the molten aluminum in the crystallizer was 700° C., the diameter of the cast ingot was of D254 mm, and the casting speed was 25 mm/min; a two-stage ceramic filter was used for filtration, with a mesh size of filter of 45 mesh and 55 mesh, respectively; the alloy ingot was subjected to homogenization at 430° C. for 12 hours, and added to a single roller belt spinner after 10 mm of the head and tail cutting and skin turning for preparation of rapid solidification strip, where the vacuum degree of the melting chamber was 3×10⁻³ Pa, and argon was introduced for protection; the melt temperature was 810° C., the rotational linear speed of the copper cooling roller was 30 m/s, the cooling water flow rate was 3,500 L/h, the pressure difference of the nozzle was 20 kPa, the liquid outflow width was 10.0 mm, the thickness of the prepared strip was 40-60 μm, and the width of the strip was 7.0-16.0 mm; the alloy strip was crushed, cleaned with alcohol and oven-dried, then subjected to sheathing and cold pressing, with a holding pressure of 200 MPa and a pressure holding time of 40 seconds to prepare a cold pressed blank of Φ 150 mm; the cold pressed blank was subjected to 1 pass of hot extrusion with an extrusion cylinder temperature of 400° C., a heating temperature of 450° C. for the raw blank, and a temperature holding time of 30 minutes; the temperature of the extrusion mold was 450° C., the extrusion ratio was 9, and the extrusion speed was 4 m/min, so that an extruded bar of Φ 50 mm was obtained; finally, the bar material was subjected to solution treatment and aging treatment, with a solution temperature of 530° C. and a solution time of 60 minutes, an aging temperature of 175° C. and an aging time of 2 hours.

The finished aluminum alloy products obtained from the above examples were tested using the following testing method:

Grain size test: the finished material was made into a smooth metallographic phase specimen, which was mechanically ground and polished, and then subjected to anodic coating treatment. It was observed and photographed under a metallographic microscope, and the average grain size was measured according to the GB/T 6394-2002 straight-line intercept method.

Micro Vickers hardness test: the finished material was made into a metallographic phase specimen of appropriate size, which was mechanically ground and polished, the hardness test of which was conducted on a Micro Vickers hardness tester, with ten hardness points for each sample, and the average value was calculated.

Precision polishing surface roughness test: the corresponding diameter of the finished material was taken, after mechanical turning, the precision turning was performed on a single point diamond lathe, and the surface roughness of precision turning was tested by using a high-precision roughness meter.

The test results of the above indicators are shown in Table 1.

TABLE 1

| | | | Precision polishing |
|---|---|---|---|
| | Average grain | Hardness by | surface |
| Test examples: | size/μm | microscopy/HV | roughness/Ra |
| Example 1 | 25 | 115 | 2.8 |
| Example 2 | 28 | 120 | 2.6 |
| Example 3 | 17 | 123 | 2.4 |
| Example 4 | 8.6 | 125 | 2.2 |
| Example 5 | 22 | 123 | 2.05 |
| Example 6 | 27 | 130 | 2.5 |
| Example 7 | 25 | 115 | 2.8 |
| Example 8 | 26 | 113 | 3.1 |
| Example 9 | 29 | 102 | 4.2 |
| Example 10 | 27 | 123 | 3.2 |
| Example 11 | 32 | 103 | 4.4 |
| Example 12 | 27 | 122 | 3.5 |
| Example 13 | 35 | 117 | 3.3 |
| Example 14 | 23 | 114 | 2.9 |
| Example 15 | 26 | 113 | 3.0 |
| Example 16 | 23 | 121 | 2.7 |
| Example 17 | 30 | 113 | 2.9 |
| Example 18 | 36 | 110 | 3.8 |
| Example 19 | 23 | 119 | 4.6 |
| Example 20 | 8.6 | 125 | 7.3 |
| Example 21 | 26 | 120 | 5.4 |

From the above descriptions, it can be seen that the embodiments of the present disclosure have achieved the following technical effects: by utilizing rapid solidification technology, the grain structure can be significantly refined, composition segregation can be reduced, and micron-sized microscopic grain structures can be obtained, which can be used for processing a highly flat surface. In addition, hot extrusion of the cold pressed raw blank prepared from the rapid solidification strips can ensure the compactness and uniform refinement of grain structure of the finished bar, which plays an important role in improving the surface state of the optical aluminum alloy finished products. The present disclosure adopts the technical route of “melt spinning-cold pressing-hot extrusion”, which can obtain finished aluminum alloy materials with uniform composition, uniform grain structure, and uniform dispersion of nanoprecipitated phase. The surface roughness of the optical aluminum alloy prepared by the present disclosure after precision machining can reach Ra of 3.0 nm or less, increasing the optical reflectivity, and having excellent tensile strength and hardness.

The above contents only describe the preferred examples of the present disclosure, and are not intended to limit the present disclosure. For those skilled in the art, various modifications and changes can be made to the present disclosure. Any modifications, equivalent substitutions, improvements, and the like made within the spirit and principle of the disclosure shall be included within the scope of protection of the disclosure.

1. A preparation method of an optical aluminum alloy, wherein the preparation method comprises the following steps:
step S1, preparing an original aluminum alloy cast ingot from raw materials by adopting a semi-continuous casting process, wherein the semi-continuous casting process comprises subjecting the raw materials to heating melting, alloying, refining, slagging-off, standing, degassing, filtering and semi-continuous water-cooling casting;
step S2, subjecting the original aluminum alloy cast ingot to homogenization, head and tail cutting and skin turning, to obtain a surface treated alloy raw material;
step S3, subjecting the surface treated alloy raw material to rapid solidification treatment through a melt spinning method to obtain a rapid solidification alloy strip;
step S4: subjecting the rapid solidification alloy strip to crushing treatment and then to sheathing and cold pressing, to obtain a cold pressed blank;
step S5, subjecting the cold pressed blank to 1-2 passes of hot extrusion procedures to prepare a bar; and
step S6, subjecting the bar to solution treatment and aging treatment, to obtain the finished aluminum alloy material.

2. The preparation method according to claim 1, wherein the original aluminum alloy cast ingot comprises the following components: a content of 0.40%-0.80% of Si, a content of ≤0.10% of Fe, a content of 0.15%-0.40% of Cu, a content of ≤0.10% of Mn, a content of 0.80%-1.20% of Mg, a content of 0.15%-0.30% of Cr, a content of ≤0.05% of Ni, a content of ≤0.25% of Zn, a content of 0.05%-0.15% of Ti, a content of 0.02%-0.04% of Zr, a content of ≤0.03% of V, a content of 0%-0.20% of Sc, with the balance being Al and impurities, the total amount of impurities being less than 0.15% and the content of each impurity element being less than 0.05%, all of which are in terms of mass percentage.

3. The preparation method according to claim 1, wherein:
the melt temperature of the alloy raw material is 730-770° C., and/or
the filtration is carried out using a two-stage ceramic filter, with a first stage filter having a pore size of 35-45 mesh and a second stage filter having a pore size of 55-65 mesh; and/or
the casting speed of the semi-continuous water-cooling casting is 20-50 mm/min, and the diameter of the original aluminum alloy cast ingot is 80-400 mm.

4. The preparation method according to claim 1, wherein in step S2, the homogenization comprises holding the original aluminum alloy cast ingot at a temperature of 490-560° C. for 8-16 hours; the length cut by the head and tail cutting is 100-150 mm, and the depth of the skin turning is 5-15 mm.

5. The preparation method according to claim 1, wherein in step S3, the rapid solidification treatment is carried out in a belt spinner, and the melting chamber of the belt spinner is filled with an inert gas, with a melt temperature of 780-850° C.

6. The preparation method according to claim 1, wherein in step S3, the rotational linear speed of the copper cooling roller for the rapid solidification treatment is 10-40 m/s, and the cooling water flow rate is 1,000-4,000 L/h.

7. The preparation method according to claim 5, wherein in step S3, the pressure difference of the nozzle of the belt spinner is 15-30 kPa, and the liquid outflow width of the nozzle is 2.0-30.0 mm.

8. The preparation method according to claim 1, wherein in step S4, the cold pressing is carried out in a cold pressing mold, with a holding pressure of 100-300 MPa and a pressure holding time of 20-600 seconds.

9. The preparation method according to claim 1, wherein:
in step S5, the extrusion cylinder temperature of the hot extrusion is 350-470° C., the heating temperature of the cold pressed blank is 350-560° C., and the temperature holding time is 20-60 minutes; and/or
the extrusion mold temperature of the hot extrusion is 300-500° C., the total extrusion ratio is 4-30, and the extrusion speed is ≤6 m/min.

10. The preparation method according to claim 1, wherein:
in step S6, the temperature of the solution treatment is 510-570° C. and the time is 30-120 minutes; and/or
the temperature of the aging treatment is 150-200° C. and the time is 1-8 hours.

11. An optical aluminum alloy, wherein the optical aluminum alloy is prepared by the preparation method of claim 1.

12. The preparation method according to claim 2, wherein the Fe content in the original aluminum alloy cast ingot is ≤0.06% in terms of mass percentage.

13. The preparation method according to claim 2, wherein the Mn content in the original aluminum alloy cast ingot is ≤0.08% in terms of mass percentage.

14. The preparation method according to claim 1, wherein the temperature of the molten aluminum in the crystallizer for the semi-continuous casting is 675-695° C.

15. The preparation method according to claim 1, wherein in the step S3, the thickness of the rapid solidification alloy strip is 15-100 μm, the width of the rapid solidification alloy strip is 2.0-30.0 mm.

16. The preparation method according to claim 1, wherein the cold pressed blank is of D 150-400 mm.
